(19) United States
(12) Patent Application Publication
(10) Pub. No.: US 2013/0161444 A1
(43) Pub. Date: Jun. 27, 2013

(54) HIGH EFFICIENCY HUB FOR PRESSURE JET HELICOPTERS

(71) Applicants: MIKE SPANOS, Chandler, AZ (US); Andrew H. Logan, Tempe, AZ (US)

(72) Inventors: MIKE SPANOS, Chandler, AZ (US); Andrew H. Logan, Tempe, AZ (US)

(73) Assignee: PEGASUS HELICOPTER, INC.

(21) Appl. No.: 13/335,887

(22) Filed: Dec. 22, 2011

(51) Int. Cl. B64C 27/06; F01D 5/18; B64C 27/18; B64C 27/16; B64C 27/473

(52) U.S. Cl. 244/17.11; 416/20 R; 416/1

(57) ABSTRACT

The various implementations of the present invention provide a high efficiency “wye” rotor hub that is introduced into the airflow of the compressed air as the compressed air is delivered to the blades of the helicopter. The hub assembly has a plurality of hollow tubes that more efficiently guide the compressed air into the hollow blades, thereby improving the efficiency and performance of the engine. The hollow rotor tube hub insert looks much like a “ram's horn” where the flow area of the compressed air entering the hollow mast from the air compressor is diverted equally into a plurality of generally circular tubes, with each tube having a substantially equal cross-sectional diameter and area and where the number of circular tubes is equal to the number of rotor blades.

### BACKGROUND OF THE INVENTION

1. Technical Field

The present invention relates generally to the field of aviation and more specifically relates to equipment and methods for increasing overall operational efficiency of certain helicopters.

2. Background Art

The most common propulsion system for helicopters, which historically has been generally employed in both commercial and military helicopters, comprises a series of mechanical interconnections of a rotor to an engine through various types of mechanical transmissions. Several disadvantages are inherent in such conventional systems, whether an internal combustion engine is used as the primary power source or whether a turbine engine is employed. A primary disadvantage of conventional helicopter power systems is that significantly high torque loads are placed on the airframe structure that is used to support the vertical shaft connecting the rotor blades with the engine.

For controllable and sustainable flight, this rotational torque must be counteracted to prevent an undesirable counter rotation of the airframe with respect to the rotor. Typically, this is accomplished by mounting a small tail rotor in a vertical plane with the hub positioned at right angles to the fore-aft axis of the helicopter body. The force applied to the body of the helicopter by the tail rotor is controlled by coordinating the pitch of the tail rotor with the drive power applied to the main rotor blades in order to obtain stable flight operation for the helicopter. Although this configuration is operable, an enormous amount of stress is placed on the body members of the helicopter fuselage as well as the transmission components used to interconnect the engine with both the main rotor and the tail rotor.

It is readily apparent that a large number of rotating and moving parts are required in a conventional helicopter in order to drive and control the two rotors. This is a significant disadvantage because many bearings, operating under significant stress (rotational, centrifugal and the like), must be employed. These bearings and the other moving mechanical parts are costly and require frequent and expensive maintenance. In fact, the maintenance and repair hours generally exceed the actual flight hours of most conventional helicopters. As a result, maintenance is a significant cost factor to be considered for the operation of a conventional helicopter.

Various attempts have been made to overcome the disadvantages of conventional mechanical drive train mechanisms. One approach is to place a jet engine or turbine at the end of each of the rotor blades. This removes the structural requirements placed upon the vertical rotor shaft in conjunction with the interconnection of the rotor to an engine located within the body of the helicopter. The hub of such a rotor-tip, jet-turbine driven helicopter then can comprise a simple rotating disc or the like with its center at the vertical rotor support shaft.

Significant fuel delivery problems, however, exist for supplying fuel from the body or fuselage of the helicopter up through the rotor support shaft and through the hub to the rotating blades. This may also present an extreme safety hazard because of the high volatility of the fuel; and leaks between the hub, the non-rotating rotor shaft, and rotating rotor blade are difficult to prevent. Furthermore, the centrifugal force acting upon the fuel due to the rotating rotor blades changes depending upon the speed of the blade. This can result in either a too rich or too lean fuel mixture supplied to the engine. In addition, the jet engines must breath their own exhaust. Consequently, power failures occur with such helicopters unless complex control mechanisms are provided for controlling the fuel supply to the engines.

To take advantage of the simplified structural requirements of the rotor blade acting as a simple rotating disc, but without the problems of conveying volatile fuel to jet engines mounted on the tips of the rotor blades, various designs utilizing the flow of pressurized air delivered through a hollow rotor shaft to hollow rotor blades have been developed. In systems using this general design, a flow of air passes through the rotor blades to nozzles or air reaction engines located at the tips of each of the blades. Consequently, air discharging through the nozzles results in reactive forces in the opposite direction to rotate the blades about the hub. A variety of attempts to develop practical helicopters using this concept of an air-driven rotor have been made in the past.

For example, in a “cold cycle” pressure jet helicopter system, a power plant drives a compressor that, in turn, delivers compressed air to the hollow axis (or mast) of the main rotor. The air passes through the hollow mast to a hollow hub, which then distributes the air to hollow rotor blades. The air passes through the hollow blades and is discharged rearward through the blade tip nozzles thereby driving the rotor by jet reaction.

This system is called “cold cycle” because the compressed air is not burned anywhere along the circuit. However, it is important to note that the air is heated by compression to around 400° F. Compression ratios are in the 2.8 to 4.0 range (absolute). Being pneumatically driven from the blade tip, the tip jet helicopter has no torque reaction and hence no tail rotor is required. However, since directional control is still desirable, some small auxiliary device is used to provide directional control to the pilot of the helicopter. Typically, the directional control comprises a directional vane mounted in the path of the engine exhaust. The pressure jet rotor blades tend to be heavy which further contributes to increased stability and safer autorotation characteristics for this helicopter.

The pneumatic drive system of the tip jet helicopter also eliminates the need for a heavy mechanical transmission that further reduces the need for maintenance and can increase reliability. The combination of these features results in a helicopter that is generally easier to fly, safer to land in power out emergencies, requires less maintenance, and is generally more reliable.

While air-driven, jet tip helicopter designs are feasible in concept, they are typically less than half as efficient as a shaft driven helicopter. This is unacceptable for most uses because of the high cost of the fuel consumed by a helicopter in flight and the necessity for storing large amounts of fuel in the helicopter fuselage, which inherently results in added weight and additional reductions in operational efficiency.

These efficiency losses occur for several reasons. For example, the relatively long path that the compressed air must travel from the compressor located within the fuselage up through the support shaft and out through the entire lengths of the blades to the tips limits the practical volume flow rate of air. Further, heat may be lost from air along the path, reducing thrust. Additional inefficiencies develop as the airflow becomes turbulent during the delivery cycle to the tips of the rotors. Accordingly, without improvements in the current drive system for tip jet helicopters, the overall process and user experience will continue to be sub-optimal.

### BRIEF SUMMARY OF THE INVENTION

The various implementations of the present invention provide a high efficiency “wye” rotor hub that is introduced into the airflow of the compressed air as the compressed air is delivered to the blades of the helicopters. The conventional hub assembly is replaced by a hub that has a plurality of hollow tubes that more efficiently guide the compressed air into the hollow blades, thereby improving the efficiency of the engine. In the most preferred embodiments of the present invention, the hollow rotor tube hub insert looks much like a “ram's horn” where the flow area of the compressed air entering the hollow mast from the air compressor is diverted equally into a plurality of generally circular tubes or air channels, with each tube having a substantially equal cross-sectional diameter and area and where the number of circular tubes is equal to the number of rotor blades. For a two bladed rotor assembly, the rotor insert would be bifurcated, for a three bladed rotor assembly, the rotor insert would be trifurcated, etc.

### BRIEF DESCRIPTION OF THE FIGURES

The preferred embodiments of the present invention will hereinafter be described in conjunction with the appended drawings, wherein like designations denote like elements, and:

FIG. 1 is a representative view of a pressure jet helicopter;

FIG. 2 is a sectional view of the airflow pattern through a prior art pressure jet hub;

FIG. 3 is a sectional view of the air flow pattern through a high efficiency pressure jet hub in accordance with a preferred exemplary embodiment of the present invention;

FIG. 4 is a perspective view of a high efficiency pressure jet hub in accordance with a preferred exemplary embodiment of the present invention;

FIG. 5 is a perspective view of a high efficiency pressure jet hub in accordance with an alternative preferred exemplary embodiment of the present invention;

FIG. 6 is a perspective view of a high efficiency pressure jet hub in accordance with an alternative preferred exemplary embodiment of the present invention;

FIG. 7 is a flow chart of a method of powering a helicopter using a high efficiency pressure jet hub in accordance with a preferred exemplary embodiment of the present invention.

### DETAILED DESCRIPTION OF THE INVENTION

The various implementations of the present invention provide a high efficiency “wye” rotor hub that is introduced into the airflow of the compressed air as the compressed air is delivered to the blades of the helicopters. The conventional hub assembly is replaced by a hub that has a plurality of hollow tubes that more efficiently guide the compressed air into the hollow blades, thereby improving the efficiency of the engine. In the most preferred embodiments of the present invention, the hollow rotor tube hub insert looks much like a “ram's horn” where the flow area of the compressed air entering the hollow mast from the air compressor is diverted equally into a plurality of generally circular air channels or tubes, with each tube having a substantially equal cross-sectional diameter and area and where the number of circular tubes is equal to the number of rotor blades. For a two bladed rotor assembly, the rotor insert would be bifurcated, for a three bladed rotor assembly, the rotor insert would be trifurcated, etc.

By channeling the compressed air more efficiently to the hollow rotor blades of the helicopter, airflow stagnation, which can be common in conventional tip jet hub designs, may be significantly reduced or eliminated which, in turn, reduces the power required to keep the blades rotating at the desired speed and results in a more efficient use of fuel.

Referring now to FIG. 1, a representative view of a pressure jet helicopter 100 is depicted. As shown in FIG. 1, the helicopter fuselage or body contains an engine 1 that produces a stream of compressed air 3. The stream of compressed air 3 is delivered to a mast 4 and then to a high efficiency hub 5. Hub 5 has a pair of air channels that divides and transmits the stream of compressed air 3 to rotor blades 6. Blades 6 are hollow body rotor blades and compressed air stream 3 is eventually discharged through blade tip nozzles 7, inducing rotational movement of blades 6. Directional control of helicopter 100 is effectuated by the movement of rudder 8, which is placed into the flow of engine exhaust 9. By varying the position of rudder 8 as engine exhaust 9 flows around it, helicopter 100 can be maneuvered by the pilot.

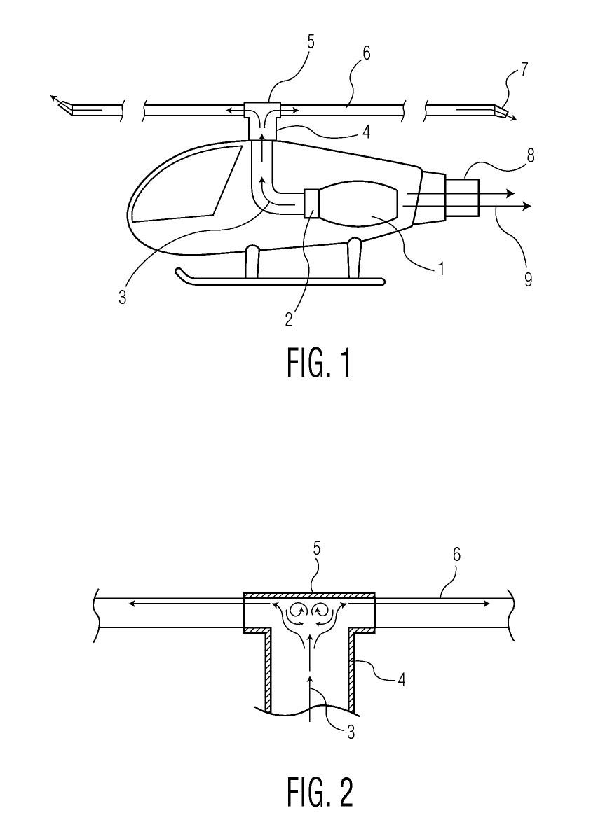

Referring now to FIG. 2, a sectional view of the airflow pattern through a prior art pressure jet hub 200 is depicted. As shown in FIG. 2, the cross sectional area of hub 200 is “T”-shaped and introduces the compressed airflow stream to a right angle from the mast. When the compressed air from the air compressor is transmitted through the hollow mast to hub 200, the compressed air stream is forced into the flat surface of the hub which may create eddies and swirling air flow patterns that generally induces a “stagnation area” and consume precious energy, reducing the efficiency of the pressure jet helicopter.

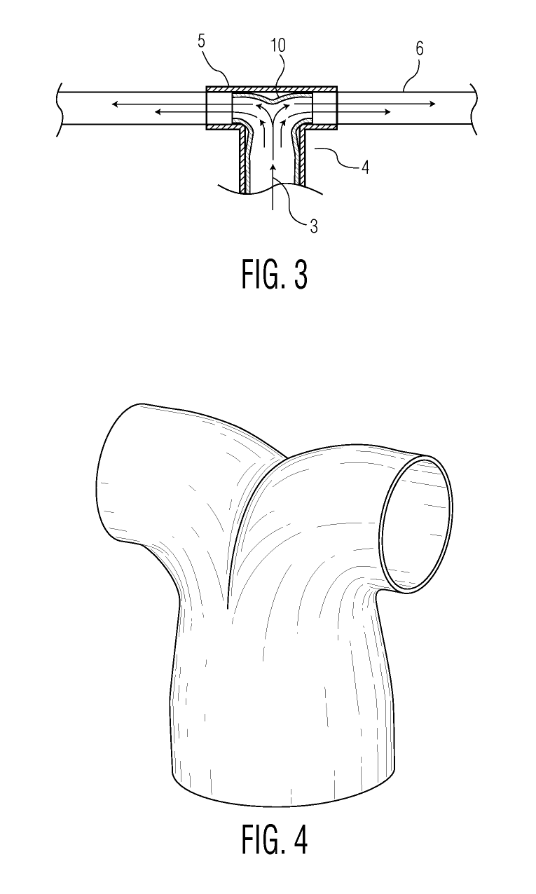

Referring now to FIG. 3, a sectional view of the airflow pattern through a high efficiency pressure jet hub 300 in accordance with a preferred exemplary embodiment of the present invention is depicted. As shown in FIG. 3, the internal design of hub 300 induces a substantially airflow through hub 300. This substantially curvilinear airflow pattern is created as the compressed air from the air compressor enters opening 310 at the bottom and is then forcefully directed out of each opening 320, where it enters into a hollow rotor blade body. Once inside the hollow rotor blade body, the substantially curvilinear airflow is transformed into a substantially linear airflow. The movement of the substantially curvilinear airflow within hub 300 is measurably more efficient than the airflow pattern exhibited in conjunction with FIG. 2 inasmuch as it reduces or eliminates the “stagnation area” that decreases the efficiency of the engine.

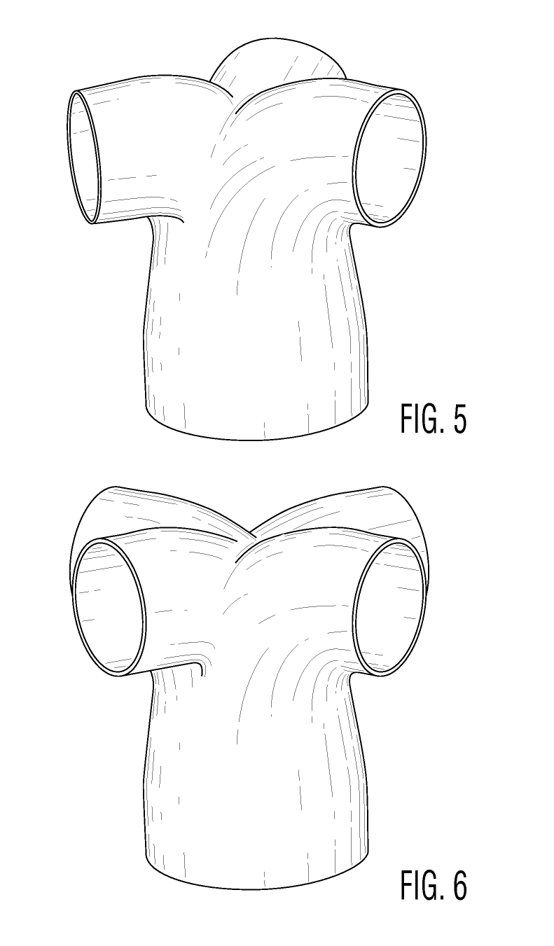

Referring now to FIG. 4, a perspective view of a high efficiency pressure jet hub 400 in accordance with a preferred exemplary embodiment of the present invention is depicted. As shown in FIG. 4, hub 400 is substantially symmetrical about a vertical plane. There is a bottom opening that receives the compresses air from the hollow mast and there are two substantially cylindrical tubular openings in the hub that are used as “air channels” that are used to channel or transfer the compressed air flow from the hollow mast to the rotor blades. As shown below in conjunction with FIG. 5, and FIG. 6, the same concept can be applied to a variety of helicopters, using variations on the design of hub 300.

Referring now to FIG. 5, a perspective view of a high efficiency pressure jet hub 500 in accordance with an alternative preferred exemplary embodiment of the present invention is depicted. As shown in FIG. 5, hub 500 is configured to support a helicopter that uses three rotor blades for flight. The compressed air stream from the air compressor is forced through a hollow mast and is then channeled to each of the three rotor blades via one of the three substantially cylindrical openings in hub 500, thereby creating three substantially curvilinear compressed air streams, and each of the three compressed air streams is delivered to the tip of a rotor blade by forcing the air flow through the hollow rotor blade.

Referring now to FIG. 6, a perspective view of a high efficiency pressure jet hub 600 in accordance with an alternative preferred exemplary embodiment of the present invention is depicted. As shown in FIG. 6, hub 600 is configured to support a helicopter that uses four rotor blades for flight. The compressed air stream from the air compressor is forced through a hollow mast and is then channeled to each of the four substantially cylindrical openings in hub 600, thereby creating four substantially curvilinear compressed air streams, and each of the four compressed air streams is delivered to the tip of a rotor blade by forcing the air flow through the hollow rotor blade.

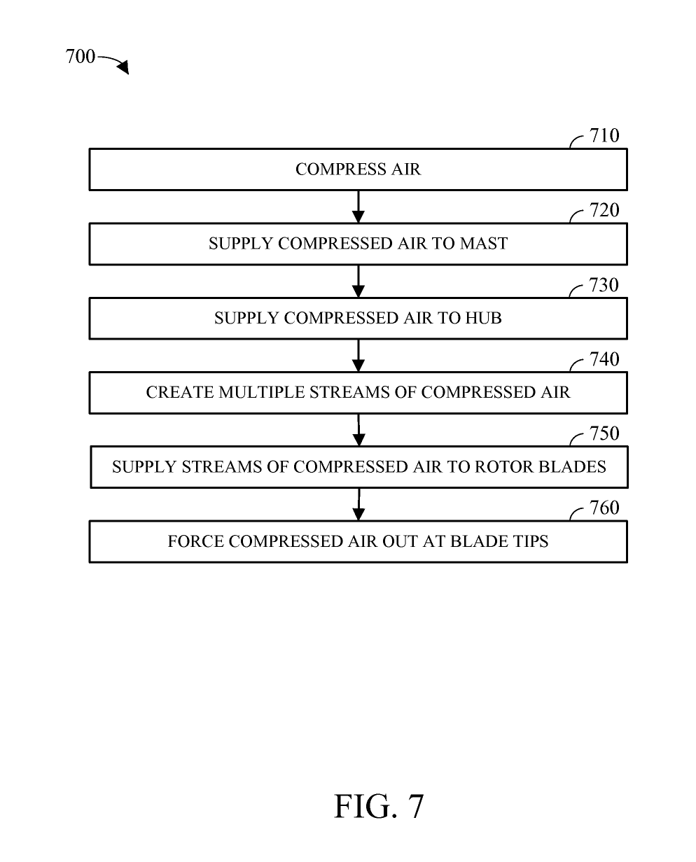

Referring now to FIG. 7, a flow chart of a method 700 of powering a helicopter using a high efficiency pressure jet hub in accordance with a preferred exemplary embodiment of the present invention. As shown in FIG. 7, the first step involves using an air compressor to create a stream of compressed air (step 710). The compressed air is then forced into the hollow mast (step 720) and forced into the high efficiency hub (step 730). Since the high efficiency hub has multiple tubular air channels, multiple streams of substantially curvilinear compressed air are created (step 740) as the compressed air is diverted through the high efficiency hub. Then, the streams of substantially curvilinear compressed air will be forced into the hollow bodies of the rotor blades (step 750) where it is transformed into a substantially linear airflow and forced our through the blade tips (step 760), causing the blades to rotate and provide the lift for the helicopter.

It should also be noted that the high efficiency hub of the present invention may be offered as a retrofit hub for existing helicopters or deployed as a new rotor assembly for original equipment manufacturers of helicopters and helicopter engines. Further, in at least one of the most preferred embodiments of the present invention, a high efficiency hub as set forth herein is packaged in a kit, with instructions on how to obtain the other components necessary (e.g., fuselage, hollow rotor blades, air compressor, engine, instrumentation, etc.) to allow an individual to construct their own helicopter, in accordance with the Federal Aviation Administration's Amateur Built Experimental Aircraft guidelines and regulations.

From the foregoing description, it should be appreciated that high efficiency hub for pressure jet helicopters disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. An apparatus comprising:
an air compressor;
a hollow mast coupled to the air compressor;
a hub connected to the hollow mast, the hub comprising a plurality of air channels for channeling the compressed air from the air compressor into a plurality of substantially curvilinear air streams; and
a plurality of hollow rotor blades connected to the hub.

2. The apparatus of claim one wherein the plurality of substantially curvilinear air channels comprises two substantially curvilinear air channels and the plurality of air streams comprises two air streams and the plurality of hollow rotor blades comprises two hollow rotor blades.

3. The apparatus of claim one wherein the plurality of air channels comprises three air channels and the plurality of substantially curvilinear air streams comprises three substantially curvilinear air streams and the plurality of hollow rotor blades comprises three hollow rotor blades.

4. The apparatus of claim one wherein the plurality of air channels comprises four air channels and the plurality of substantially curvilinear air streams comprises four substantially curvilinear air streams and the plurality of hollow rotor blades comprises four hollow rotor blades.

5. The apparatus of claim one further wherein the air compressor is contained within a helicopter fuselage and the hollow rotor blades are used to propel the helicopter fuselage during flight.

6. The apparatus of claim 1 further comprising:
an exhaust stream from the air compressor; and
a rudder positioned in the exhaust stream.

7. The apparatus of claim 1 further comprising a tip nozzle at the end of each of the plurality of hollow rotor blades.

8. The apparatus of claim 1 wherein each of the plurality of air channels comprises a cross-sectional diameter and area that is substantially equal to a cross-sectional diameter and area for each of the other plurality of air channels.

9. The apparatus of claim 1 further comprising:
an exhaust stream from the air compressor;
a rudder positioned in the exhaust stream, and wherein:
the air compressor is contained within a helicopter fuselage;
the plurality of substantially curvilinear air channels comprises two substantially curvilinear air channels;
the plurality of air streams comprises two air streams;
the plurality of hollow rotor blades comprises two hollow rotor blades and further comprising a tip nozzle at the end of each of the two hollow rotor blades; and
the hollow rotor blades are used to propel the helicopter fuselage during flight.

10. The apparatus of claim 1 wherein the hub comprising a plurality of air channels is provided as an after market product to replace a conventional “T”-shaped hub.

11. A method comprising the steps of:
transmitting a flow of compressed air through a hollow mast to a hub, the hub comprising a plurality of substantially circular tubes, thereby creating a plurality of substantially curvilinear air streams; and
supplying the plurality of substantially curvilinear air streams to a plurality of hollow rotor blades, where the number of substantially curvilinear air streams is equal to the number of hollow rotor blades;
transforming the substantially curvilinear air streams into substantially linear air streams within the hollow rotor blades; and
discharging the substantially linear air streams through a tip nozzle in the end of each of the plurality of hollow rotor blades, thereby inducing a rotational movement in the plurality of hollow rotor blades.

12. The method of claim 11 wherein the step of supplying the plurality of substantially curvilinear air streams to the plurality of hollow rotor blades comprises the step of supplying a substantially curvilinear air stream to each of two hollow rotor blades.

13. The method of claim 11 wherein the step of supplying the plurality of substantially curvilinear air streams to the plurality of hollow rotor blades comprises the step of supplying a substantially curvilinear air stream to each of three hollow rotor blades.

14. The method of claim 11 wherein the step of supplying each of the plurality of substantially curvilinear air streams to each of a plurality of hollow rotor blades comprises the step of supplying a substantially curvilinear air stream to each of four hollow rotor blades.

15. The method of claim 11 further comprising the step of using the rotational movement in the plurality of rotor blades to power a helicopter in flight.

16. The method of claim 11 wherein the flow of compressed air is generated by an air compressor and further comprising the step of positioning a rudder in an exhaust stream from the air compressor.

17. The method of claim 11 wherein each of the plurality of substantially circular tubes comprises a substantially equal cross-sectional diameter and area.

18. The method of claim 11 wherein the step of supplying the plurality of substantially curvilinear air streams to the plurality of hollow rotor blades comprises the step of supplying a substantially curvilinear air stream to each of two hollow rotor blades and discharging the substantially linear air streams through a tip nozzle in the end of each of the plurality of hollow rotor blades, thereby inducing a rotational movement in the plurality of hollow rotor blades.

19. A helicopter comprising a plurality of components, the plurality of components comprising:
a helicopter fuselage;
an air compressor;
a hollow mast coupled to the air compressor;
a hub coupled to the air compressor, the hub comprising a pair of substantially tubular air channels; and
a pair of hollow rotor blades attached to the hub wherein each of the pair of hollow rotor blades is supplied an air stream from the pair of substantially tubular air channels.

20. The helicopter of claim 19 wherein at least the hub is provided in a kit.
